(19) United States
(12) Patent Application Publication
(10) Pub. No.: US 2020/0273411 A1
(43) Pub. Date: Aug. 27, 2020

(54) PIXEL CIRCUIT AND DRIVING METHOD THEREOF, AND DISPLAY DEVICE

(71) Applicant: BOE TECHNOLOGY GROUP CO., LTD., Beijing (CN)

(72) Inventors: Xueling GAO, Beijing (CN); Kuanjun PENG, Beijing (CN); Chengchung YANG, Beijing (CN); Xiangxiang ZOU, Beijing (CN); Wei QIN, Beijing (CN)

(21) Appl. No.: 16/650,217

(22) PCT Filed: Sep. 17, 2018
(86) PCT No.: PCT/CN2018/105999

§ 371 Date: Mar. 24, 2020

(30) Foreign Application Priority Data
Sep. 30, 2017 (CN) 201710917398.9

(51) Int. Cl. G09G 3/3291

(52) U.S. Cl. CPC G09G 3/3291; G09G 2310/0278; G09G 2310/062

(57) ABSTRACT

A pixel circuit and a driving method thereof and a display device are provided. In the pixel circuit, a driving circuit is configured to control a driving current flowing through a first terminal and a second terminal of the driving circuit for driving a light emitter element to emit light; a data writing circuit is configured to write a data signal to a control terminal of the driving circuit in response to a scan signal; a first light emission control circuit is configured to apply a first voltage to the first terminal in response to a first light emission control signal; a first reset circuit is configured to apply a reset voltage to the control terminal in response to a first reset signal. The driving circuit is in a fixed bias state when the reset voltage and the first voltage are applied together to the driving circuit.

The application claims priority to the Chinese patent application No. 201710917398.9 filed on Sep. 30, 2017, the entire disclosure of which is incorporated herein by reference as part of the present application.

### TECHNICAL FIELD

The embodiments of the present disclosure relate to a pixel circuit and a driving method thereof and a display device.

### BACKGROUND

An organic light emitting diode (OLED) display device is gradually attracting attention of people because of advantages such as wide view angle, high contrast, rapid response and higher luminance and lower driving voltage compared with an inorganic light emitting display device. Due to the above characteristics, the organic light emitting diode can be applied in a device having a display function such as a cellphone, a display, a notebook computer, a digital camera, instrument and apparatus and the like.

A pixel circuit of the OLED display device usually adopts a matrix driving manner, and the matrix driving manner is categorized as active matrix (AM) driving and passive matrix (PM) driving according to whether a switch element is in each pixel unit. PMOLED is of simple process and low cost but cannot satisfy requirements of high-resolution and large-size display due to disadvantages such as crosstalk, high power consumption and short lifetime. In contrast, in AMOLED, a set of thin film transistor and storage capacitor is integrated in the pixel circuit of each pixel, and control over a current passing through the OLED is realized by controlling driving of the thin film transistor and the storage capacitor, so as to enable the OLED to emit light according to needs. Compared with PMOLED, AMOLED needs a smaller driving current and has lower power consumption and a longer lifetime, so as to be able to satisfy requirements of high-resolution, multiple-grayscale and large-size display. Meanwhile, AMOLED has obvious advantages in respects such as viewing angle, color rendition, power consumption and response time, and is applicable in a high-information content and high-resolution display device.

### SUMMARY

At least one embodiment of the present disclosure provides a pixel circuit, including: a driving circuit, a data writing circuit, a first reset circuit, a first light emission control circuit and a light emitter element. The driving circuit includes a control terminal, a first terminal and a second terminal, and the driving circuit is configured to control a driving current, which passes through the first terminal and the second terminal, for driving the light emitter element to emit light; the data writing circuit is configured to write a data signal into the control terminal of the driving circuit in response to a scan signal; the first light emission control circuit is configured to apply a first voltage to the first terminal of the driving circuit in response to a first light emission control signal; the first reset circuit is configured to apply a reset voltage to the control terminal of the driving circuit in response to a first reset signal, and the driving circuit is configured to be in a fixed bias state in a situation where the reset voltage and the first voltage are applied together to the driving circuit.

For example, in the pixel circuit provided by at least an embodiment of the present disclosure, the first reset signal and the first light emission control signal are simultaneously turn-on signals during at least a period of time.

For example, in the pixel circuit provided by at least an embodiment of the present disclosure, the driving circuit includes a first transistor; a gate electrode of the first transistor serves as the control terminal of the driving circuit to connect a first node, a first electrode of the first transistor serves as the first terminal of the driving circuit to connect a second node, and a second electrode of the first transistor serves as the second terminal of the driving circuit to connect a third node; the first transistor is in the fixed bias state in the situation where the reset voltage and the first voltage are applied together to the first transistor.

For example, in the pixel circuit provided by at least an embodiment of the present disclosure, the data writing circuit includes a second transistor; a gate electrode of the second transistor is configured to be connected with a scan signal terminal to receive the scan signal, a first electrode of the second transistor is configured to be connected with a data signal terminal to receive the data signal, and a second electrode of the second transistor is connected with the second node.

For example, the pixel circuit provided by at least an embodiment of the present disclosure further includes a compensation circuit configured to store the data signal that is written in and to compensate the driving circuit in response to the scan signal.

For example, in the pixel circuit provided by at least an embodiment of the present disclosure, the compensation circuit includes a third transistor and a storage capacitor; a gate electrode of the third transistor is configured to be connected with a scan signal terminal to receive the scan signal, a first electrode of the third transistor is connected with the third node, a second electrode of the third transistor is connected with a first electrode of the storage capacitor, and a second electrode of the storage capacitor is configured to be connected with a first voltage terminal.

For example, in the pixel circuit provided by at least an embodiment of the present disclosure, the first reset circuit includes a fourth transistor; a gate electrode of the fourth transistor is configured to be connected with a first reset control terminal to receive the first reset signal, a first electrode of the fourth transistor is connected with the first node, and a second electrode of the fourth transistor is configured to be connected with a reset voltage terminal to receive the reset voltage.

For example, in the pixel circuit provided by at least an embodiment of the present disclosure, the first light emission control circuit includes a fifth transistor; a gate electrode of the fifth transistor is configured to be connected with a first light emission control terminal to receive the first light emission control signal, a first electrode of the fifth transistor is configured to be connected with a first voltage terminal to receive the first voltage, and a second electrode of the fifth transistor is connected with the second node.

For example, the pixel circuit provided by at least an embodiment of the present disclosure further includes a second light emission control circuit configured to apply the driving current to the light emitter element in response to a second light emission control signal; the second light emission control signal is different from the first light emission control signal.

For example, in the pixel circuit provided by at least an embodiment of the present disclosure, the second light emission control circuit includes a sixth transistor; a gate electrode of the sixth transistor is configured to be connected with a second light emission control terminal to receive the second light emission control signal, a first electrode of the sixth transistor is connected with the third node, a second electrode of the sixth transistor is connected with a fourth node, a first electrode of the light emitter element is configured to be connected with the fourth node, and a second electrode of the light emitter element is configured to be connected with a second voltage terminal to receive a second voltage.

For example, the pixel circuit provided by at least an embodiment of the present disclosure further includes a second reset circuit configured to apply the reset voltage to the second terminal of the driving circuit in response to a second reset signal; the second reset signal is different from the first reset signal.

For example, in the pixel circuit provided by at least an embodiment of the present disclosure, the second reset circuit includes a seventh transistor; a gate electrode of the seventh transistor is configured to be connected with a second reset control terminal to receive the second reset signal, a first electrode of the seventh transistor is connected with the fourth node, and a second electrode of the seventh transistor is configured to be connected with a reset voltage terminal to receive the reset voltage.

For example, in the pixel circuit provided by at least an embodiment of the present disclosure, the first light emission control signal and the second light emission control signal are simultaneously turn-on signals during at least a period of time.

At least one embodiment of the present disclosure further provides a display device including a plurality of pixel units distributed in an array, a plurality of scan signal lines, a plurality of data signal lines and a plurality of light emission control lines; each pixel unit includes the pixel circuit provided by at least one embodiment of the present disclosure, the scan signal line of an Nth row is connected with both the data writing circuit and a compensation circuit which are in the pixel circuit of the Nth row to provide the scan signal; the data signal line of an Mth column is connected with the data writing circuit in the pixel circuit of the Mth column to provide the data signal; the scan signal line of an (N−1)th row is connected with the first reset circuit in the pixel circuit of the (N−1)th row, and the scan signal input by the scan signal line of the Nth row serves as the first reset signal which is provided to the first reset circuit; the light emission control line of an (N+1)th row is connected with the first light emission control circuit in the pixel circuit of the Nth row to provide the first light emission control signal; N is an integer larger than 1, and M is an integer larger than 0.

For example, in the display device provided by at least an embodiment of the present disclosure, the pixel circuit further includes: a second light emission control circuit configured to apply the driving current to the light emitter element in response to a second light emission control signal which is different from the first light emission control signal; and a second reset circuit configured to apply the reset voltage to the second terminal of the driving circuit and the compensation circuit in response to a second reset signal which is different from the first reset signal. The light emission control line of the Nth row is connected with the second light emission control circuit in the pixel circuit of the Nth row to provide the second light emission control signal; the scan signal line of the (N+1)th row is connected with the second reset circuit in the pixel circuit of the Nth row, and the scan signal input by the scan signal line of the (N+1)th row serves as the second reset signal which is provided to the second reset circuit.

At least one embodiment of the present disclosure further provides a display device including a plurality of pixel units distributed in an array, a plurality of scan signal lines, a plurality of data signal lines, a plurality of reset control lines and a plurality of light emission control lines; each pixel unit includes the pixel circuit provided by at least one embodiment of the present disclosure, the scan signal line of an Nth row is connected with both the data writing circuit and a compensation circuit which are in the pixel circuit of the Nth row to provide the scan signal; the data signal line of an Mth column is connected with the data writing circuit in the pixel circuit of the Mth column to provide the data signal; the reset control line of the Nth row is connected with the first reset circuit in the pixel circuit of the Nth row to provide the first rest signal; the light emission control line of an (N+1)th row is connected with the first light emission control circuit in the pixel circuit of the Nth row to provide the first light emission control signal; N and M are integers larger than 0.

For example, in the display device provided by at least an embodiment of the present disclosure, the pixel circuit further includes: a second light emission control circuit configured to apply the driving current to the light emitter element in response to a second light emission control signal which is different from the first light emission control signal; and a second reset circuit configured to apply the reset voltage to the second terminal of the driving circuit and the compensation circuit in response to a second reset signal which is different from the first reset signal. The light emission control line of the Nth row is connected with the second light emission control circuit in the pixel circuit of the Nth row to provide the second light emission control signal; the reset control line of the (N+1)th row is connected with the second reset circuit in the pixel circuit of the Nth row to provide the second reset signal.

At least one embodiment of the present disclosure further provides a driving method of the pixel circuit provided by at least one embodiment of the present disclosure, and the driving method includes an initialization stage. In the initialization stage, the first reset signal is input, the first reset circuit is turned on, the reset voltage is applied to the control terminal of the driving circuit, the first light emission control signal is input, the first light emission control circuit is turned on, and the first voltage is applied to the first terminal of the driving circuit, so that the driving circuit is in the fixed bias state.

At least one embodiment of the present disclosure further provides a driving method of the pixel circuit provided by at least one embodiment of the present disclosure, and the driving method includes an initialization stage, a data writing and compensation stage, a reset stage and a light emission stage. In the initialization stage, the first reset signal is input, the first reset circuit is turned on, the reset voltage is applied to the control terminal of the driving circuit, the first light emission control signal is input, the first light emission control circuit is turned on, the first voltage is applied to the first terminal of the driving circuit, so that the driving circuit is in the fixed bias state; in the data writing and compensation stage, the scan signal and the data signal are input, the data writing circuit, the driving circuit and the compensation circuit are turned on, the data writing circuit writes the data signal into the driving circuit, and the compensation circuit compensates the driving circuit; in a reset stage, the second light emission control signal and the second reset signal are input, the second light emission control circuit and the second reset circuit are turned on, and the driving circuit, the compensation circuit and the light emitter element are reset; and in the light emission stage, the first light emission control signal and the second light emission control signal are input, the first light emission control circuit, the second light emission control circuit and the driving circuit are turned on, and the second light emission control circuit applies the driving current to the light emitter element to drive the light emitter element to emit light.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1A is a schematic diagram of image one displayed by a display device;

FIG. 1B is a schematic diagram of image two to be displayed by the display device;

FIG. 1C is a schematic diagram of image two actually displayed by the display device;

FIG. 2 is a schematic block diagram of a pixel circuit provided by an embodiment of the present disclosure;

FIG. 3 is a circuit diagram of an example of the pixel circuit as illustrated in FIG. 2;

FIG. 4 is a signal timing diagram corresponding to operation of the pixel circuit shown in FIG. 3;

FIG. 5 to FIG. 8 are respectively schematic circuit diagrams of the pixel circuit as illustrated in FIG. 3 corresponding to four signal timing stages in FIG. 4;

FIG. 9 is another circuit diagram of the pixel circuit provided by an embodiment of the present disclosure;

FIG. 10 is a schematic diagram of the display device provided by an embodiment of the present disclosure; and

FIG. 11 is another schematic diagram of the display device provided by an embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment (s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Also, the terms such as “a,” “an,” etc., are not intended to limit the amount, but indicate the existence of at least one. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “left,” “right” and the like are only used to indicate relative position relationship, and when the position of the object which is described is changed, the relative position relationship may be changed accordingly.

Because of a lag effect of a driving transistor, when a display device displays a same image for a period of time and switches the image currently displayed to a next image, the original image partially remains and emerges in the next image, and then the residual image disappears after a period of time, and this phenomenon is called short-term residual image. The lag effect is mainly caused by a shift of a threshold voltage (Vth) caused by movable ions remaining in holes. A V_{GS} (voltage difference between a gate electrode of the driving transistor and a source electrode of the driving transistor) in an initialization stage may be different during switching of different images, and therefore it may cause the shifts of the threshold voltage of the driving transistor to different degrees, resulting in the short-term residual image.

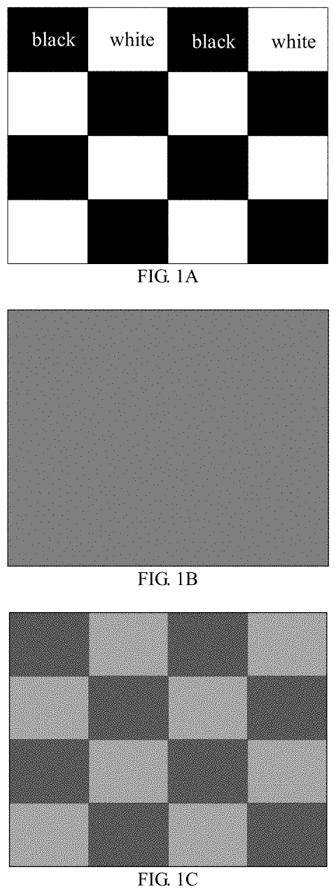

For example, FIG. 1A is a schematic diagram of image one displayed by a display device, FIG. 1B is a schematic diagram of image two to be displayed by the display device, and FIG. 1C is a schematic diagram of the image two actually displayed by the display device. After the display device displays the image one such as a black-and-white checkerboard image as illustrated in FIG. 1A for a period of time, when the image displayed by the display device is switched to the new image two such as an image with a gray scale of 48 as illustrated in FIG. 1B, the checkerboard image as illustrated in FIG. 1A still partially remains, and the image actually displayed is illustrated in FIG. 1C.

At least an embodiment of the present disclosure provides a pixel circuit, and the pixel circuit includes a driving circuit, a data writing circuit, a first reset circuit, a first light emission control circuit and a light emitter element. The driving circuit includes a control terminal, a first terminal and a second terminal, and the driving circuit is configured to control a driving current which passes through the first terminal and the second terminal, and the driving current is used to drive the light emitter element to emit light; the data writing circuit is configured to write a data signal into the control terminal of the driving circuit in response to a scan signal; the first light emission control circuit is configured to apply a first voltage to the first terminal of the driving circuit in response to a first light emission control signal; the first reset circuit is configured to apply a reset voltage to the control terminal of the driving circuit in response to a first reset signal, and the driving circuit is configured to be in a fixed bias state when the reset voltage and the first voltage are applied simultaneously to the driving circuit. The embodiments of the present disclosure further provide a driving method corresponding to the above mentioned pixel circuit and a display device.

The pixel circuit, the driving method thereof and the display device provided by the embodiments of the present disclosure can enable the driving transistor to be in an on state where V_{GS} is under fixed bias in an initialization stage, and then enable the driving transistor to start to enter a data writing and compensation stage, for example, so as to reduce the phenomenon of the short-term residual image possibly caused by the lag effect.

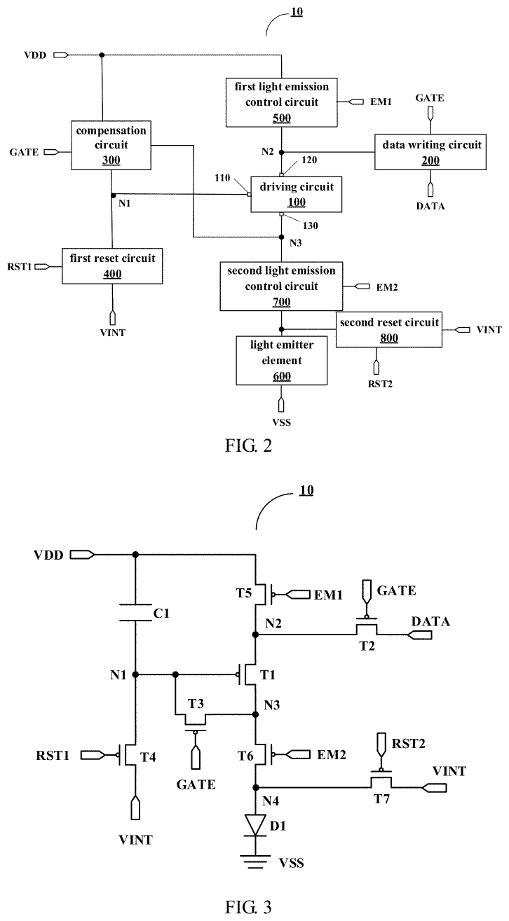

An embodiment of the present disclosure provides a pixel circuit 10, and the pixel circuit 10 can be used for a sub-pixel of an OLED display device, for example. As illustrated in FIG. 2, the pixel circuit 10 includes a driving circuit 100, a data writing circuit 200, a compensation circuit 300, a first reset circuit 400, a first light emission control circuit 500 and a light emitter element 600.

For example, the driving circuit 100 includes a control terminal 110, a first terminal 120 and a second terminal 130, the driving circuit 100 is connected with the data writing circuit 200, the compensation circuit 300, the first reset circuit 400 and the first light emission control circuit 500, and the driving circuit 100 is configured to control a driving current that passes through the first terminal 120 and the second terminal 130, and the driving current is used to drive the light emitter element 600 to emit light. For example, in a light emission stage, the driving circuit 100 provides the driving current to the light emitter element 600 to drive the light emitter element 600 to emit light and for example, the light emitter element 600 can emit light according to a desired “gray scale”. For example, the light emitter element 600 adopts an OLED, and embodiments of the present disclosure include but are not limited to this.

For example, the data writing circuit 200 is connected with the driving circuit 100 and the first light emission control circuit 500, and the data writing circuit 200 is configured to write a data signal DATA into the control terminal 110 of the driving circuit 100 in response to a scan signal GATE. For example, in the data writing and compensation stage, the data writing circuit 200 is turned on in response to the scan signal GATE, thereby writing a data signal DATA into the control terminal 110 of the driving circuit 100 and storing the data signal DATA in the compensation circuit 300, so that the driving current for driving the light emitter element 600 to emit light is generated according to the data signal DATA in the light emission stage, for example.

For example, the compensation circuit 300 is connected with the driving circuit 100 and the first reset circuit 400, and the compensation circuit 300 is configured to store the data signal DATA that is written in and to compensate the driving circuit 100 in response to the scan signal GATE. For example, in a case where the compensation circuit 300 includes a storage capacitor, the compensation circuit 300 is turned on in response to the scan signal GATE in the data writing and compensation stage, so as to store the data signal DATA that is written in by the data writing circuit 200 in the storage capacitor. For example, simultaneously, in the data writing and compensation stage, the compensation circuit 300 electrically connects the control terminal 110 of the driving circuit 100 and the second terminal 130 of the driving circuit 100, so that relevant information of the threshold voltage of the driving circuit 100 can be correspondingly stored in the storage capacitor, and thus the driving circuit 100 can be controlled by using the stored data including the data signal DATA and the threshold voltage in the light emission stage, so that the driving circuit 100 can be compensated.

For example, the first light emission control circuit 500 is connected with the driving circuit 100 and the data writing circuit 200, and the first light emission control circuit 500 is configured to apply a first voltage VDD to the first terminal 120 of the driving circuit 100 in response to a first light emission control signal EM1. For example, in the initialization stage, the first light emission control circuit 500 is turned on in response to the first light emission control signal EM1, so as to apply the first voltage VDD to the first terminal 120 of the driving circuit 100. For another example, in the light emission stage, the first light emission control circuit 500 is turned on in response to the first light emission control signal EM1, so as to apply the first voltage VDD to the first terminal 120 of the driving circuit 100. When the driving circuit 100 is turned on, it is easy to understand that an electric potential of the second terminal 130 is also VDD. Then, the driving circuit 100 applies the first voltage VDD to the light emitter element 600 to provide a driving voltage to drive the light emitter element to emit light. For example, the first voltage VDD is the driving voltage, which is, for example, a high voltage.

For example, the first reset circuit 400 is connected with the driving circuit 100 and the compensation circuit 300, and the first reset circuit 400 is configured to apply a reset voltage VINT to the control terminal 110 of the driving circuit 100 in response to a first reset signal RST1. For example, in the initialization stage, the first reset circuit 400 is turned on in response to the first reset signal RST1, so as to apply the reset voltage VINT to the control terminal 110 of the driving circuit, and the first reset circuit 400 is configured to allow the driving circuit to be in a fixed bias state, for example, an on state of fixed bias, when the reset voltage VINT and the first voltage VDD are applied together.

In a case where the driving circuit 100 is implemented as a driving transistor, for example, a gate electrode of the driving transistor serves as the control terminal of the driving circuit 100, a first electrode (for example, a source electrode) serves as the first terminal of the driving circuit 100, and a second electrode (for example, a drain electrode) serves as the second terminal of the driving circuit 100.

For example, the first reset signal RST1 and the first light emission control signal EM1 are both turn-on signals during at least a period of time. For example, in the initialization stage of the above pixel circuit 10, the first reset signal RST1 and the first light emission control signal EM1 are both turn-on signals, so that the reset voltage VINT can be applied to the gate electrode of the driving transistor while the first voltage VDD is applied to the source electrode of the driving transistor. Therefore, the voltage V_{GS} for driving the gate electrode and the source electrode of the driving transistor can satisfies: |V_{GS}|>|Vₜₕ| (Vₜₕ represents the threshold voltage of the driving transistor, for example, Vth is a negative value in a case where the driving transistor is a p-type transistor), so that the driving transistor is in the on state where V_{GS} is under the fixed bias. With this configuration, it can be realized that whether the data signal DATA of a previous frame is a black state signal or a white state signal, the driving transistor starts to enter the data writing and compensation stage from the on state of the fixed bias, for example. Thereby, the phenomenon of short-term residual image possibly caused by the lag effect of the display device adopting the pixel circuit can be reduced.

For example, as illustrated in FIG. 2, in another embodiment of the present disclosure, the pixel circuit 10 further includes a second light emission control circuit 700 which is connected with the driving circuit 100, the compensation circuit 300 and the light emitter element 600, and which is configured to apply the driving current to the light emitter element 600 in response to a second light emission control signal EM2.

For example, in the light emission stage, the second light emission control circuit 700 is turned on in response to the second light emission control signal EM2, so that the driving circuit 100 applies the driving current to the light emitter element 600 by means of the second light emission control circuit 700 to drive the light emitter element 600 to emit light; in a non-light emission stage, the second light emission control circuit 700 is turned off in response to the second light emission control signal EM2, thereby preventing the light emitter element 600 from emitting light and providing contrast of the corresponding display device.

For example, in some examples, the second light emission control circuit 700 is turned on in response to the second light emission control signal EM2 in a reset stage, so that the second light emission control circuit 700 can combine with other reset circuit to perform reset operations on the driving circuit 100 and the light emitter element 600.

For example, the second light emission control signal EM2 is different from the first light emission control signal EM1. For example, the second light emission control signal EM2 and the first light emission control signal EM1 are connected with different signal output terminals, and as described above, for example, the second light emission control signal EM2 may be individually a turn-on signal in the reset stage. For example, the first light emission control signal and the second light emission control signal are both turn-on signals during at least a period of time. For example, in the light emission stage, the first light emission control signal EM1 and the second light emission control signal EM2 are both turn-on signals to drive the light emitter element 600 to emit light.

It should be noted that in the embodiments of the present disclosure, the first light emission control signal EM1 and the second light emission control signal EM2 are used to distinguish two light emission control signals with different timing. For example, in a display device, in a case where the pixel circuits 10 are arranged in an array, the first light emission control signal EM1 may be a control signal for controlling the first light emission control circuit 500 in a present row of pixel circuits 10, while the first light emission control signal EM1 also controls the second light emission control circuit 700 in a next row of pixel circuits 10; similarly, the second light emission control signal EM2 is a control signal for controlling the second light emission control circuit 700 in the present row of pixel circuits 10, while the second light emission control signal EM2 also controls the first light emission control circuit 500 in a previous row of pixel circuits 10.

For example, as illustrated in FIG. 2, in another embodiment of the present disclosure, the pixel circuit 10 may further include a second reset circuit 800, the second reset circuit 800 is connected with the second light emission control circuit 700 and the light emitter element 600, and the second reset circuit 800 is configured to apply a reset voltage (for example, also VINT) to the second terminal 130 of the driving circuit 100 in response to a second reset signal RST2.

For example, in the reset stage, the second reset circuit 800 is turned on in response to the second reset signal RST2, and the second light emission control circuit 700 is also turned on simultaneously in this stage as described above, so that the reset voltage VINT is applied to the second terminal 130 of the driving circuit 100 to realize the reset operation.

For example, the second reset signal RST2 is different from the first reset signal RST1, and the second reset signal RST2 and the first reset signal RST1 may be connected with different signal output terminals. For example, the first reset signal RST1 and the second reset signal RST2 are configured to be respectively provided by two different reset control lines. For example, in a display device, in the case where the pixel circuits 10 are arranged in an array, the first reset signal RST1 is provided by a scan signal line of the previous row, and the second reset signal RST2 is provided by a scan signal line of the next row.

For example, the pixel circuit 10 illustrated in FIG. 2 is implemented as the structure of the pixel circuit illustrated in FIG. 3. As illustrated in FIG. 3, the pixel circuit 10 includes a first transistor T1, a second transistor T2, a third transistor T3, a fourth transistor T4, a fifth transistor T5, a sixth transistor T6 and a seventh transistor T7, and includes a storage capacitor C1 and a light emitter element DE For example, the first transistor T1 is used as a driving transistor, and the rest second to seventh transistors are used as switching transistors. For example, the light emitter element D1 is an OLED, and the embodiments of the present disclosure include but are not limited to this. The following embodiments are all described by taking that the light emitter element D1 is the OLED as an example and are not described in detail. The OLED may be of various types, such as top emission, bottom emission or the like, and the OLED may emit red light, green light, blue light, white light, or the like. The embodiments of the present disclosure impose no limitation to this.

For example, as illustrated in FIG. 3, more specifically, the driving circuit 100 may be implemented as the first transistor T1. A gate electrode of the first transistor T1 functions as the control terminal 110 of the driving circuit 100 and is connected with a first node N1, a first electrode of the first transistor T1 functions as the first terminal 120 of the driving circuit 100 and is connected with a second node N2, and a second electrode of the first transistor T1 functions as the second terminal 130 of the driving circuit 100 and is connected with a third node N3. For example, the first transistor T1 is in a fixed bias state, for example, in an on state of the fixed bias when the reset voltage VINT and the first voltage VDD are applied simultaneously to the first transistor T1.

The data writing circuit 200 may be implemented as the second transistor T2. A gate electrode of the second transistor T2 is configured to be connected with a scan signal terminal to receive the scan signal GATE, a first electrode of the second transistor T2 is configured to be connected with a data signal terminal to receive the data signal DATA, and a second electrode of the second transistor T2 is connected with the second node N2.

The compensation circuit 300 may be implemented to include the third transistor T3 and the storage capacitor C1. A gate electrode of the third transistor T3 is configured to be connected with the scan signal terminal to receive the scan signal GATE, a first electrode of the third transistor T3 is connected with the third node N3, a second electrode of the third transistor T3 is connected with a first electrode (the first node N1) of the storage capacitor C1, and a second electrode of the storage capacitor C1 is configured to be connected with the first voltage terminal to receive the first voltage VDD.

The first reset circuit 400 may be implemented as the fourth transistor T4. A gate electrode of the fourth transistor is configured to be connected with a first reset control terminal to receive the first reset signal RST1, a first electrode of the fourth transistor is connected with the first node, and a second electrode of the fourth transistor is configured to be connected with a reset voltage terminal to receive the reset voltage VINT.

The first light emission control circuit 500 may be implemented as the fifth transistor T5. A gate electrode of the fifth transistor T5 is configured to be connected with a first light emission control terminal to receive the first light emission control signal EM1, a first electrode of the fifth transistor T5 is configured to be connected with the first voltage terminal to receive the first voltage VDD, and a second electrode of the fifth transistor T5 is connected with the second node N2.

The second light emission control circuit 700 may be implemented as the sixth transistor T6. A gate electrode of the sixth transistor T6 is configured to be connected with a second light emission control terminal to receive the second light emission control signal EM2, a first electrode of the sixth transistor T6 is connected with a third node N3, a second electrode of the sixth transistor T6 is connected with a fourth node N4.

A first electrode (anode) of the light emitter element D1 is configured to be connected with the fourth node N4, and a second electrode (cathode) of the light emitter element D1 is configured to be connected with a second voltage terminal to receive a second voltage VSS. For example, the second voltage terminal may be grounded, that is, VSS may be 0V.

The second reset circuit 800 may be implemented as the seventh transistor T7. A gate electrode of the seventh transistor T7 is configured to be connected with a second reset control terminal to receive a second reset signal RST2, a first electrode of the seventh transistor T7 is connected with the fourth node N4, and a second electrode of the seventh transistor T7 is configured to be connected with the reset voltage terminal to receive the reset voltage VINT. For example, the reset voltage VINT is 0V (or other low-level signals, etc.).

It should be noted that all the transistors adopted in the embodiments of the present disclosure may be thin film transistors, field-effect transistors or other switchers with same characteristics and thin film transistors are taken as an example to illustrated in the embodiments of the present disclosure. Source electrodes and drain electrodes of the transistors adopted herein may be symmetric in structure, so there is no difference between the source electrodes and drain electrodes in structure. In the embodiments of the present disclosure, in order to distinguish the two electrodes apart from the gate electrode, one electrode of the source electrode and the drain electrode is described as the first electrode and the other electrode of the source electrode and the drain electrode is described as the second electrode.

Additionally, it should be noted that the transistors in the embodiments of the present disclosure are all described by taking P-type transistors as an example. In this case, the first electrode may be the source electrode and the second electrode may be the drain electrode. As illustrated in FIG. 3, the cathode of the light emitter element D1 in the pixel circuit 10 is connected with the second voltage terminal to receive the second voltage VSS. For example, in a display device, in the case where the pixel circuits 10 illustrated in FIG. 3 are arranged in an array, the cathodes of the light emitter elements D1 may be electrically connected with a same voltage terminal, that is, the manner that the light emitter elements D1 are connected by sharing one cathode is adopted.

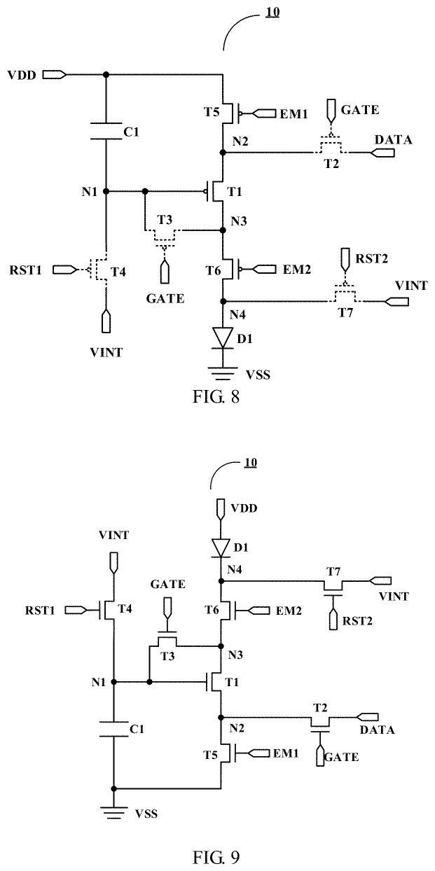

The embodiments of the present disclosure include but are not limited to the configuration mode in FIG. 3. For example, as illustrated in FIG. 9, in another embodiment of the present disclosure, the transistors in the pixel circuit 10 may all adopt N-type transistors, in this case, the first electrode may be the drain electrode and the second electrode may be the source electrode. In the embodiment illustrated in FIG. 9, the anode of the light emitter element D1 in the pixel circuit 10 is connected with the first voltage terminal to receive the first voltage VDD. For example, in a display device, in the case where the pixel circuits 10 illustrated in FIG. 9 are arranged in an array, the anodes of the light emitter elements D1 may be electrically connected with a same voltage terminal (for example, a common voltage terminal), that is, a connection mode that the light emitter elements D1 share one anode is adopted. The connection relationship of other transistors in this embodiment is illustrated in FIG. 9 and is not be repeated here.

For another example, the transistors in the embodiments of the present disclosure may include both P-type transistors and N-type transistors, and it is only required that polarities of terminals of the selected types of transistors are connected correspondingly according to the polarities of the terminals of the corresponding transistors in the embodiments of the present disclosure.

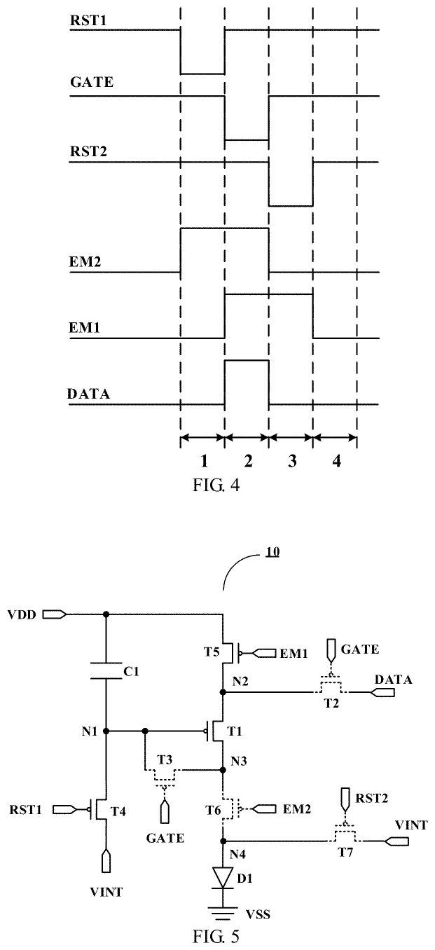

The operation principle of the pixel circuit 10 illustrated in FIG. 3 is described below with reference to a signal timing diagram illustrated in FIG. 4. As illustrated in FIG. 4, the operation of the pixel circuit 10 includes four stages, namely the initialization stage 1, the data writing and compensation stage 2, the reset stage 3 and the light emission stage 4, and timing waveform of each signal in each stage is illustrated in FIG. 4.

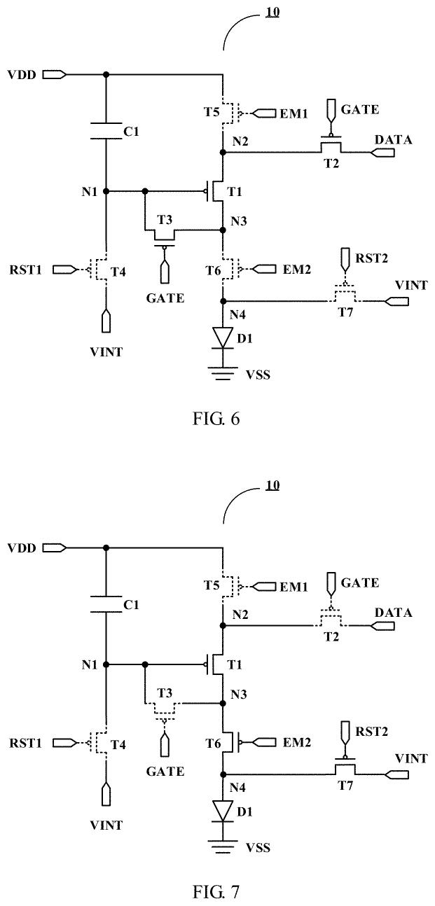

It should be noted that FIG. 5 is a schematic diagram when the pixel circuit 10 illustrated in FIG. 3 is in the initialization stage 1, FIG. 6 is a schematic diagram when the pixel circuit 10 illustrated in FIG. 3 is in the data writing and compensation stage 2, FIG. 7 is a schematic diagram when the pixel circuit 10 illustrated in FIG. 3 is in the reset stage 3, and FIG. 8 is a schematic diagram when the pixel circuit 10 illustrated in FIG. 3 is in the light emission stage 4. In addition, the transistors identified by dashed lines in FIG. 5 to FIG. 8 all indicate that they are in an off state in the corresponding stages. The transistors illustrated in FIG. 5 to FIG. 8 all take P-type transistors as an example, that is, the gate electrode of each transistor is turned on when a low level is input and is turned off when a high level is input.

In the initialization stage 1, the first reset signal RST1 is input, the first reset circuit 400 is turned on, and the reset voltage VINT is applied to the control terminal 110 of the driving circuit 100; the first light emission control signal EM1 is input, the first light emission control circuit 500 is turned on, and the first voltage VDD is applied to the first terminal 120 of the driving circuit 100.

As illustrated in FIG. 4 and FIG. 5, in the initialization stage 1, the fourth transistor T4 is turned on by a low level of the first reset signal RST1, and the fifth transistor T5 is turned on by a low level of the first light emission control signal EM1; at the same time, the second transistor T2, the third transistor T3, the sixth transistor T6 and the seventh transistor T7 are turned off by high-level signals respectively input thereto.

In the initialization stage 1, because the fourth transistor T4 is turned on, the reset voltage VINT (a low-level signal which may be grounded or other low-level signal, for example) may be applied to the gate electrode of the first transistor T1. At the same time, because the fifth transistor T5 is turned on, the first voltage VDD (a high level signal) may be applied to the source electrode of the first transistor T1, so that in this stage, the voltage difference V_{GS} between the gate electrode of the first transistor T1 and the source electrode of the first transistor T1 satisfy: |V_{GS}|>|Vₜₕ| (Vₜₕ is the threshold voltage of the first transistor T1, for example, Vth is a negative value when the first transistor T1 is a P-type transistor), thereby allowing the first transistor T1 to be in the on state in which V_{GS} is under the fixed bias. With this configuration, it can be realized that whether the data signal DATA of the previous frame is a black-state signal or a white-state signal, the first transistor T1 starts to enter the data writing and compensation stage 2 from the on state of the fixed bias, thereby inhibiting the phenomenon of short-term residual image that may occur because of the lag effect in the display device adopting the pixel circuit 10.

In the data writing and compensation stage 2, the scanning signal GATE and the DATA signal DATA are input, and the data writing circuit 200, the driving circuit 100 and the compensation circuit 300 are turned on; the data writing circuit 200 writes the data signal DATA into the driving circuit 100, and the compensation circuit 300 compensates the driving circuit 100.

As illustrated in FIG. 4 and FIG. 6, in the data writing and compensation stage 2, the second transistor T2 and the third transistor T3 are turned on by a low level of the scan signal GATE. At the same time, the fourth transistor T4, the fifth transistor T5, the sixth transistor T6 and the seventh transistor T7 are turned off by high-level signals respectively input thereto.

As illustrated in FIG. 6, in the data writing and compensation stage 2, the data signal DATA passes through the second transistor T2, the first transistor T1 and the third transistor T3 to charge the first node N1 (that is, to charge the storage capacitor C1), that is, the electric potential of the first node N1 becomes larger. It is easy to understand that the electric potential of the second node N2 is maintained at Vdata, and at the same time, according to the own characteristics of the first transistor T1, when the electric potential of the first node N1 increases to Vdata+Vth, the first transistor T1 is turned off and the charging process ends. It should be noted that Vdata represents the voltage value of the data signal DATA, and Vth represents the threshold voltage of the first transistor. In this embodiment, the pixel circuit is described by taking that the first transistor T1 is a P-type transistor as an example, so the threshold voltage Vth may be a negative value here.

After the data writing and compensation stage 2, the electric potentials of the first node N1 and the third node N3 are both Vdata+Vth, that is, voltage information with the data signal DATA and the threshold voltage Vth is stored in the storage capacitor C1 for providing gray scale display data and compensating for the threshold voltage of the first transistor T1 itself in the subsequent light emission stage.

In the reset stage 3, the second light emission control signal EM2 and the second reset signal RST2 are input, the second light emission control circuit 700 and the second reset circuit 800 are turned on, and the driving circuit 100, the compensation circuit 300 and the light emitter element 600 are reset.

As illustrated in FIG. 4 and FIG. 7, in the reset stage 3, the sixth transistor T6 is turned on by a low level of the second light emission control signal EM2, and the seventh transistor T7 is turned on by a low level of the second reset signal RST2; at the same time, the second transistor T2, the third transistor T3, the fourth transistor T4 and the fifth transistor T5 are turned off by high levels respectively input thereto.

As illustrated in FIG. 7, in the reset stage 3, because the reset voltage VINT is a low-level signal (for example, it may be grounded or other low-level signal), the drain electrode of the first transistor T1 is discharged by means of the sixth transistor T6 and the seventh transistor T7, thereby resetting the electric potentials of the third node N3 and the fourth node N4 at the same time.

In the reset stage 3, the drain electrode of the first transistor T1 is reset, so that the electric potential of the drain electrode of the first transistor T1 can be kept at a fixed electric potential without affecting the display effect of the display device adopting the above pixel circuit because of the uncertainty of the electric potential of the drain electrode of the first transistor T1. At the same time, the fourth node N4 is also reset, that is, the OLED is reset, so that the OLED displays in a black state without emitting light before the light emission stage 4, and the display effect such as contrast of the display device adopting the pixel circuit 10 described above is improved.

In the light emission stage 4, the first light emission control signal EM1 and the second light emission control signal EM2 are input, the first light emission control circuit 500, the second light emission control circuit 700 and the driving circuit 100 are turned on, and the second light emission control circuit 700 applies the driving current to the light emitter element 600 to drive the light emitter element 600 to emit light.

As illustrated in FIG. 4 and FIG. 8, in the light emission stage 4, the fifth transistor T5 is turned on by the low level of the first light emission control signal EM1, and the sixth transistor T6 is turned on by the low level of the second light emission control signal EM2; the second transistor T2, the third transistor T3, the fourth transistor T4 and the seventh transistor T7 are turned off by high levels respectively input thereto; at the same time, the electric potential of the first node N1 is Vdata+Vth, and the electric potential of the second node N2 is VDD, and therefore the first transistor T1 is also kept on at this stage.

As illustrated in FIG. 8, in the light emission stage 4, the anode and the cathode of the light emitter element D1 are respectively input with the first voltage VDD (high voltage) and the second voltage VSS (low voltage), so that the light emitter element D1 emits light under the action of the driving current that passes through the first transistor T1.

Specifically, the value of the driving current ID1 that passes through the light emitter element D1 can be obtained according to the following formula:

$$\begin{matrix}{I}_{D 1} = {K ( {V}_{GS} - Vth )}^{2} \\ = {K [ ( Vdata + Vth - VDD ) - Vth ]}^{2} \\ = {K ( Vdata - VDD )}^{2} .\end{matrix}$$

In the above formula, Vth represents the threshold voltage of the first transistor T1, V_{GS} represents the voltage difference between the gate electrode of the first transistor T1 and the source electrode of the first transistor T1, and K is a constant value. It can be seen from the above formula that the driving current ID1 passing through the light emitter element D1 is no longer related to the threshold voltage Vth of the first transistor T1, but only related to the voltage Vdata of the data signal DATA controlling the light emission gray scale of the pixel circuit, thereby realizing compensation for the pixel circuit, solving the threshold voltage drift of the driving transistor (the first transistor T1 in the embodiments of the present disclosure) caused by the manufacturing process and long-term operation, eliminating influence of the threshold voltage drift on the driving current ID1, and thus improving the display effect.

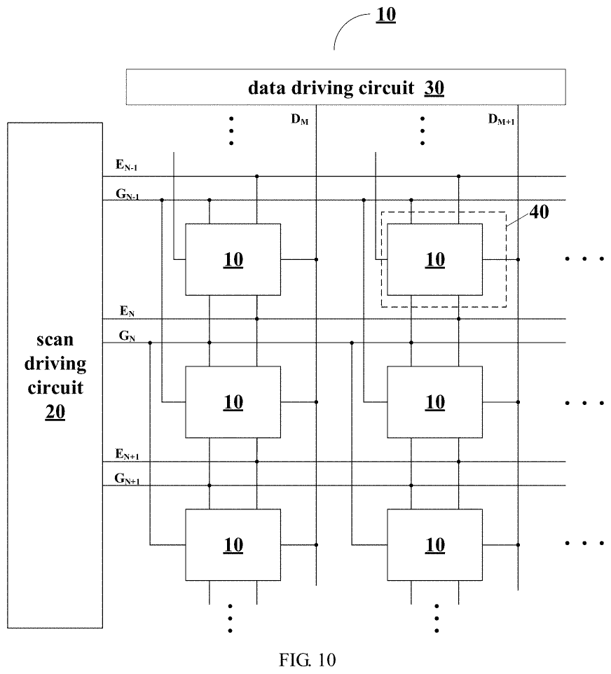

At least one embodiment of the present disclosure further provides a display device 1. As illustrated in FIG. 10, the display device 1 includes a plurality of pixel units 40 arranged in an array, a plurality of scan signal lines, a plurality of data signal lines and a plurality of light emission control lines. It should be noted that only a part of the pixel units 40, the scan signal lines, the data signal lines and the light emission control lines are illustrated in FIG. 10, and embodiments of the present disclosure include but are not limited to this. For example, G_{N-1} represents the scan signal line of an (N−1)th row, G_{N} represents the scan signal line of an Nth row, G_{N+1} represents the scan signal line of an (N+1)th row; E_{N-1} represents the light emission control line of the (N−1)th row, EN represents the light emission control line of the Nth row, and E_{N+1} represents the light emission control line of the (N+1)th row; D_{M} represents the data signal line of an Mth column, and D_{M+1} represents the data signal line of an (M+1)th column Here, N is, for example, an integer larger than 1, and M is, for example, an integer larger than 0.

For example, each of the pixel units 40 includes the pixel circuit 10 provided in any one of the above embodiments; for example, each of the pixel units 40 includes the pixel circuit 10 illustrated in FIG. 3.

For example, the scan signal line G_{N} of the Nth row is connected with the data writing circuit and the compensation circuit which are in the pixel circuit 10 of the Nth row to provide the scan signal GATE; the data signal line DM of the Mth column is connected with the data writing circuit in the pixel circuit 10 of the Mth column to provide the data signal DATA; the scan signal line G_{N-1} of the (N−1)th row is connected with the first reset circuit in the pixel circuit 10 of the Nth row, and the scan signal input by the scan signal line G_{N-1} of the (N−1)th row serves as the first reset signal RST1 and is provided to the first reset circuit; the light emission control line E_{N+1} of the (N+1)th row is connected with the first light emission control circuit in the pixel circuit 10 of the Nth row to provide the first light emission control signal EM1.

For example, in the case where the pixel circuit 10 includes the second light emission control circuit and the second reset circuit, the light emission control line EN of the Nth row is connected with the second light emission control circuit in the pixel circuit 10 of the Nth row to provide the second light emission control signal EM2; the scan signal line G_{N+1} of the (N+1)th row is connected with the second reset circuit in the pixel circuit 10 of the Nth row, and the scan signal input by the scan signal line G_{N+1} of the (N+1)th row serves as the second reset signal RST2 and is provided to the second reset circuit.

As described above, in the display device 1 provided in this embodiment, the pixel circuit 10 of each row is connected with the scan signal line of the present row in which the pixel circuit 10 is located, and also connected with the scan signal line of the previous row adjacent to the present row, so that the scan signal GATE provided by the scan signal line of the previous row is used as the first reset signal RST1 of the pixel circuit of the present row; at the same time, the pixel circuit 10 is also connected with the scan signal line of the next row adjacent to the present row, so that the scan signal GATE provided by the scan signal line of the next row is used as the second reset signal RST2 of the pixel circuit of the present row.

At the same time, the pixel circuit 10 of each row is connected with the light emission control line of the present row and connected with the light emission control line of the next row adjacent to the present row, so that the signal provided by the light emission control line of the next row is used as the first light emission control signal EM1 of the pixel circuit of the present row.

In the display device 1 provided in this embodiment, the development layout can be simplified by adopting the above-described arrangement. Other technical effects may be referred to the technical effects of the pixel circuit provided in the embodiments of the present disclosure and are not be repeated here.

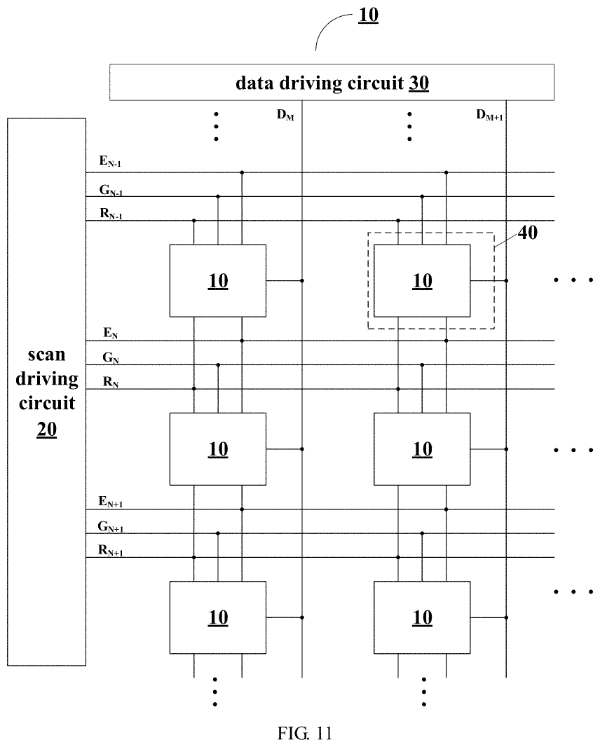

Another embodiment of the present disclosure further provides the display device 1. As illustrated in FIG. 11, the display device 1 provided in this embodiment differs from the display device illustrated in FIG. 10 in that the display device 1 further includes a plurality of reset control lines (R_{N-1}, R_{N}, R_{N+1}, etc.), only a part of the reset control lines are illustrated in FIG. 11, and the embodiment of the present disclosure includes but is not limited to this. For example, R_{N-1} represents the reset control line of the (N−1) the row, R_{N} represents the reset control line of the Nth row, and R_{N+1} represents the reset control line of the (N+1)th row. In the display device 1 provided in this embodiment, the first reset signal RST1 and the second reset signal RST2 in the pixel circuit 10 of each row are no longer provided by the scan signal lines of adjacent rows, but are provided by the reset control lines.

For example, as illustrated in FIG. 11, in this embodiment, the pixel circuit 10 of each row is only connected with the scan signal line of the present row where the pixel circuit 10 is located, and is no longer connected with the scan signal line of the row adjacent to the present row. At the same time, the pixel circuit 10 of each row is connected with two reset control lines, for example, the reset control line R_{N-1} of the (N−1)th row is connected with the first reset circuit of the pixel circuit 10 of the (N−1)th row to provide the first reset signal RST1, and the reset control line R_{N} of the Nth row is connected with the second reset circuit of the pixel circuit 10 of the (N−1)th row to provide the second reset signal RST2. Similarly, the reset control line R_{N} of the Nth row is connected with the first reset circuit in the pixel circuit 10 of the Nth row to provide the first reset signal RST1, and the reset control line R_{N+1} of the (N+1)th row is connected with the second reset circuit in the pixel circuit 10 of the Nth row to provide the second reset signal RST2. That is, the pixel circuit 10 of each row is connected with the reset control line of the present row where the pixel circuit 10 is located and the reset control line of the next row.

Other parts and technical effects of this embodiment can be referred to the corresponding description in the embodiment provided in FIG. 10, and is not repeated here.

It should be noted that the display device 1 illustrated in FIG. 10 and FIG. 11 may further include a plurality of first voltage lines and a plurality of reset voltage lines to respectively provide the first voltage VDD and the reset voltage VINT (not illustrated in the figure).

For example, as illustrated in FIG. 10 and FIG. 11, the display device 1 may further include a scan driving circuit 20 and a data driving circuit 30.

For example, the data driving circuit 30 is connected with the plurality of data signal lines (D_{M}, D_{M+1}, etc.) to provide the data signal DATA; at the same time, the data driving circuit 30 may also be connected with a plurality of first voltage lines (not illustrated) and a plurality of reset voltage lines (not illustrated) to respectively provide the first voltage VDD and the reset voltage VINT.

For example, the scan driving circuit 20 is connected with the plurality of scan signal lines (G_{N-1}, G_{N}, G_{N+1}, etc.) to provide the scan signal GATE, and the scan driving circuit 20 is connected with the plurality of light emission control lines (E_{N-1}, EN, E_{N+1}, etc.) to provide the light emission control signal; in the case where the display device 1 includes the plurality of reset control lines (as illustrated in FIG. 11), the scan driving circuit 20 may also be connected with the plurality of reset control lines (R_{N-1}, R_{N}, R_{N+1}, etc.) to provide the reset signal.

For example, the scan driving circuit 20 and the data driving circuit 30 may be implemented as semiconductor chips. The display device 1 may also include other components, such as a timing controller, a signal decoding circuit, a voltage conversion circuit, etc. These components may, for example, adopt existing conventional components and are not be described in detail here.

For example, the display device 1 provided by the embodiments of the present disclosure may be any product or component with a display function, such as electronic paper, mobile phone, tablet computer, television, display, notebook computer, digital photo frame, navigator, and so on.

At least one embodiment of the present disclosure further provides a driving method that can be used to drive the pixel circuit 10 provided by the embodiments of the present disclosure and the display device 1 adopting the pixel circuit 10. For example, the driving method includes the following operations.

In the initialization stage, the first reset signal RST1 is input, the first reset circuit 400 is turned on, and the reset voltage VINT is applied to the control terminal 110 of the driving circuit 100; the first light emission control signal EM1 is input, the first light emission control circuit 500 is turned on, and the first voltage VDD is applied to the first terminal 120 of the driving circuit 100, so that the driving circuit 100 is in a fixed bias state, for example, in an on state of the fixed bias.

In the data writing and compensation stage, the scan signal GATE and the data signal DATA are input, and the data writing circuit 200, the driving circuit 100 and the compensation circuit 300 are turned on; the data writing circuit 200 writes the data signal DATA into the driving circuit 100, and the compensation circuit 300 compensates the driving circuit 100.

In the reset stage, the second light emission control signal EM2 and the second reset signal RST2 are input, the second light emission control circuit 700 and the second reset circuit 800 are turned on, and the driving circuit 100, the compensation circuit 300 and the light emitter element 600 are reset.

In the light emission stage, the first light emission control signal EM1 and the second light emission control signal EM2 are input, the first light emission control circuit 500, the second light emission control circuit 700 and the driving circuit 100 are turned on, and thus the second light emission control circuit 700 applies the driving current to the light emitter element 600 to drive the light emitter element 600 to emit light.

It should be noted that the detailed description of the driving method can be referred to the description of the working principle of the pixel circuit 10 in the embodiments of the present disclosure, and is not repeated here.

The driving method provided by the embodiments of the present disclosure can inhibit the phenomenon of short-term residual image that may occur because of the lag effect.

What have been described above are only specific implementations of the present disclosure, the protection scope of the present disclosure is not limited thereto. The protection scope of the present disclosure should be based on the protection scope of the claims.

1. A pixel circuit, comprising: a driving circuit, a data writing circuit, a first reset circuit, a first light emission control circuit and a light emitter element, wherein
the driving circuit comprises a control terminal, a first terminal and a second terminal, and the driving circuit is configured to control a driving current, which passes through the first terminal and the second terminal, for driving the light emitter element to emit light;
the data writing circuit is configured to write a data signal into the control terminal of the driving circuit in response to a scan signal;
the first light emission control circuit is configured to apply a first voltage to the first terminal of the driving circuit in response to a first light emission control signal;
the first reset circuit is configured to apply a reset voltage to the control terminal of the driving circuit in response to a first reset signal, and the driving circuit is configured to be in a fixed bias state in a situation where the reset voltage and the first voltage are applied together to the driving circuit.

2. The pixel circuit according to claim 1, wherein
the first reset signal and the first light emission control signal are simultaneously turn-on signals during at least a period of time.

3. The pixel circuit according to claim 1, wherein
the driving circuit comprises a first transistor;
a gate electrode of the first transistor serves as the control terminal of the driving circuit to connect a first node, a first electrode of the first transistor serves as the first terminal of the driving circuit to connect a second node, and a second electrode of the first transistor serves as the second terminal of the driving circuit to connect a third node;
the first transistor is in the fixed bias state in the situation where the reset voltage and the first voltage are applied together to the first transistor.

4. The pixel circuit according to claim 3, wherein
the data writing circuit comprises a second transistor;
a gate electrode of the second transistor is configured to be connected with a scan signal terminal to receive the scan signal, a first electrode of the second transistor is configured to be connected with a data signal terminal to receive the data signal, and a second electrode of the second transistor is connected with the second node.

5. The pixel circuit according to claim 3, further comprising a compensation circuit configured to store the data signal that is written in and to compensate the driving circuit in response to the scan signal.

6. The pixel circuit according to claim 5, wherein the compensation circuit comprises a third transistor and a storage capacitor;
a gate electrode of the third transistor is configured to be connected with a scan signal terminal to receive the scan signal, a first electrode of the third transistor is connected with the third node, a second electrode of the third transistor is connected with a first electrode of the storage capacitor, and a second electrode of the storage capacitor is configured to be connected with a first voltage terminal.

7. The pixel circuit according to claim 3, wherein
the first reset circuit comprises a fourth transistor;
a gate electrode of the fourth transistor is configured to be connected with a first reset control terminal to receive the first reset signal, a first electrode of the fourth transistor is connected with the first node, and a second electrode of the fourth transistor is configured to be connected with a reset voltage terminal to receive the reset voltage.

8. The pixel circuit according to claim 3, wherein
the first light emission control circuit comprises a fifth transistor;
a gate electrode of the fifth transistor is configured to be connected with a first light emission control terminal to receive the first light emission control signal, a first electrode of the fifth transistor is configured to be connected with a first voltage terminal to receive the first voltage, and a second electrode of the fifth transistor is connected with the second node.

9. The pixel circuit according to claim 1, further comprising a second light emission control circuit configured to apply the driving current to the light emitter element in response to a second light emission control signal, wherein
the second light emission control signal is different from the first light emission control signal.

10. The pixel circuit according to claim 3, further comprising a second light emission control circuit configured to apply the driving current to the light emitter element in response to a second light emission control signal, wherein
the second light emission control signal is different from the first light emission control signal.

11. The pixel circuit according to claim 10, wherein
the second light emission control circuit comprises a sixth transistor;
a gate electrode of the sixth transistor is configured to be connected with a second light emission control terminal to receive the second light emission control signal, a first electrode of the sixth transistor is connected with the third node, a second electrode of the sixth transistor is connected with a fourth node,
a first electrode of the light emitter element is configured to be connected with the fourth node, and a second electrode of the light emitter element is configured to be connected with a second voltage terminal to receive a second voltage.

12. The pixel circuit according to claim 11, further comprising a second reset circuit configured to apply the reset voltage to the second terminal of the driving circuit in response to a second reset signal, wherein
the second reset signal is different from the first reset signal.

13. The pixel circuit according to claim 12, wherein the second reset circuit comprises a seventh transistor;
a gate electrode of the seventh transistor is configured to be connected with a second reset control terminal to receive the second reset signal, a first electrode of the seventh transistor is connected with the fourth node, and a second electrode of the seventh transistor is configured to be connected with a reset voltage terminal to receive the reset voltage.

14. (canceled)

15. The pixel circuit according to claim 9, wherein the first light emission control signal and the second light emission control signal are simultaneously turn-on signals during at least a period of time.

16. A display device, comprising a plurality of pixel units distributed in an array, a plurality of scan signal lines, a plurality of data signal lines and a plurality of light emission control lines, wherein
each pixel unit comprises the pixel circuit according to claim 1,
the scan signal line of an Nth row is connected with both the data writing circuit and a compensation circuit which are in the pixel circuit of the Nth row to provide the scan signal;
the data signal line of an Mth column is connected with the data writing circuit in the pixel circuit of the Mth column to provide the data signal;
the scan signal line of an (N−1)th row is connected with the first reset circuit in the pixel circuit of the Nth row, and the scan signal input by the scan signal line of the (N−1)th row serves as the first reset signal which is provided to the first reset circuit;
the light emission control line of an (N+1)th row is connected with the first light emission control circuit in the pixel circuit of the Nth row to provide the first light emission control signal;
N is an integer larger than 1, and M is an integer larger than 0.

17. The display device according to claim 16, wherein the pixel circuit further comprises:
a second light emission control circuit configured to apply the driving current to the light emitter element in response to a second light emission control signal, wherein the second light emission control signal is different from the first light emission control signal; and
a second reset circuit configured to apply the reset voltage to the second terminal of the driving circuit and the compensation circuit in response to a second reset signal, wherein the second reset signal is different from the first reset signal;
wherein the light emission control line of the Nth row is connected with the second light emission control circuit in the pixel circuit of the Nth row to provide the second light emission control signal;
the scan signal line of the (N+1)th row is connected with the second reset circuit in the pixel circuit of the Nth row, and the scan signal input by the scan signal line of the (N+1)th row serves as the second reset signal which is provided to the second reset circuit.

18. A display device, comprising a plurality of pixel units distributed in an array, a plurality of scan signal lines, a plurality of data signal lines, a plurality of reset control lines and a plurality of light emission control lines, wherein
each pixel unit comprises the pixel circuit according to claim 1,
the scan signal line of an Nth row is connected with both the data writing circuit and a compensation circuit which are in the pixel circuit of the Nth row to provide the scan signal;
the data signal line of an Mth column is connected with the data writing circuit in the pixel circuit of the Mth column to provide the data signal;
the reset control line of the Nth row is connected with the first reset circuit in the pixel circuit of the Nth row to provide the first reset signal;
the light emission control line of an (N+1)th row is connected with the first light emission control circuit in the pixel circuit of the Nth row to provide the first light emission control signal;
N and M are integers larger than 0.

19. The display device according to claim 18, wherein the pixel circuit further comprises:
a second light emission control circuit configured to apply the driving current to the light emitter element in response to a second light emission control signal, wherein the second light emission control signal is different from the first light emission control signal; and
a second reset circuit configured to apply the reset voltage to the second terminal of the driving circuit and the compensation circuit in response to a second reset signal, wherein the second reset signal is different from the first reset signal;
wherein the light emission control line of the Nth row is connected with the second light emission control circuit in the pixel circuit of the Nth row to provide the second light emission control signal;
the reset control line of the (N+1)th row is connected with the second reset circuit in the pixel circuit of the Nth row to provide the second reset signal.

20. A driving method of the pixel circuit according to claim 1, comprising an initialization stage, wherein
in the initialization stage, the first reset signal is input, the first reset circuit is turned on, the reset voltage is applied to the control terminal of the driving circuit, the first light emission control signal is input, the first light emission control circuit is turned on, and the first voltage is applied to the first terminal of the driving circuit, so that the driving circuit is in the fixed bias state.

21. A driving method of the pixel circuit according to claim 12, comprising an initialization stage, a data writing and compensation stage, a reset stage and a light emission stage, wherein
in the initialization stage, the first reset signal is input, the first reset circuit is turned on, the reset voltage is applied to the control terminal of the driving circuit, the first light emission control signal is input, the first light emission control circuit is turned on, the first voltage is applied to the first terminal of the driving circuit, so that the driving circuit is in the fixed bias state;
in the data writing and compensation stage, the scan signal and the data signal are input, the data writing circuit, the driving circuit and the compensation circuit are turned on, the data writing circuit writes the data signal into the driving circuit, and the compensation circuit compensates the driving circuit;
in a reset stage, the second light emission control signal and the second reset signal are input, the second light emission control circuit and the second reset circuit are turned on, and the driving circuit, the compensation circuit and the light emitter element are reset; and
in the light emission stage, the first light emission control signal and the second light emission control signal are input, the first light emission control circuit, the second light emission control circuit and the driving circuit are turned on, and the second light emission control circuit applies the driving current to the light emitter element to drive the light emitter element to emit light.
